(19) United States
(12) Patent Application Publication
(10) Pub. No.: US 2025/0380640 A1
(43) Pub. Date: Dec. 18, 2025

(54) AGRICULTURAL WORKING MACHINE WITH AT LEAST ONE CONTROL DEVICE

(71) Applicant: CLAAS Selbstfahrende Erntemaschinen GmbH, Harsewinkel (DE)

(72) Inventors: Waldemar Thiesmann, Harsewinkel (DE); Christoph Bussmann, Harsewinkel (DE); Matthias Domnik, Oelde (DE); Henner Vöcking, Rietberg (DE); Bastian Bormann, Gütersloh (DE); Andreas Wilken, Bissendorf (DE)

(73) Assignee: CLAAS Selbstfahrende Erntemaschinen GmbH, Harsewinkel (DE)

(21) Appl. No.: 19/235,846

(22) Filed: Jun. 12, 2025

(30) Foreign Application Priority Data
Jun. 12, 2024 (DE) 10 2024 116 461.1

(51) Int. Cl. A01D 41/127; A01D 41/06

(52) U.S. Cl. CPC A01D 41/127; A01D 41/06

(57) ABSTRACT

An agricultural work machine with at least one control and regulation device. The control and regulation device is configured to activate defined measuring points in saved characteristic curve fields, wherein the defined measuring points are located in the edge regions of the characteristic curve field and/or outside an active operating region of the given characteristic curve field. Further, the measuring points may be activated when the agricultural work machine is in an uncritical state.

### CROSS REFERENCE TO RELATED APPLICATION

This application claims priority under 35 U.S.C. § 119 to German Patent Application No. DE 10 2024 116 461.1 filed Jun. 12, 2024, the entire disclosure of which is hereby incorporated by reference herein.

### TECHNICAL FIELD

The present invention relates to an agricultural work machine with at least one control and regulation device.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A control and regulation device may monitor and optimize work and quality parameters of an agricultural work machine. The optimization or the implementation of an optimization method may include the activation of measuring points. As one example, the control and regulation device may be optimized using the measuring points.

To this end, DE 10 2006 044 628, incorporated by reference herein in its entirety, discloses a method in which a certain number of parameters are optimized depending on one another. This particularized activation of machine parameters is further developed in US Patent Application Publication No. 2010/0217474 A1, incorporated by reference in its entirety. Specifically, US Patent Application Publication No. 2010/0217474 A1, among others, discloses performing optimization of adjustable machine parameters depending on events, whereby the operator of the agricultural work machine may always be kept informed of the ongoing optimization processes via a display unit.

US Patent Application Publication No. 2014/0019017 A1, incorporated by reference in its entirety, discloses an agricultural working machine having a control/regulating unit configured to adjust and monitor working parameters, quality parameters or both of the agricultural working machine that may influence a harvesting process. The control/regulating unit may automatically perform the adjusting and monitoring by using stored families of characteristics. The agricultural working machine may also have a display device configured to depict setpoint values and actual values of the working parameters, quality parameters or both. The control/regulating unit may actuate defined measurement points in the stored families of characteristics and the specifically actuated measurement points may be located in the boundary regions of the family of characteristics or outside the active operating region of the particular family of characteristics.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic representation of an agricultural work machine designed as a combine harvester.

FIG. 2 illustrates an example of a schematic representation of a display structure of a control and regulation device.

FIG. 3 includes FIGS. 3a-d, which illustrate examples of schematic representations of the display structure of the control and regulation device in different operating situations.

FIG. 4 illustrates an example of a schematic representation of a digital field map.

FIG. 5 illustrates an example of a schematic representation of the digital field map comprising an obstacle region and a non-critical region.

### DETAILED DESCRIPTION

As discussed in the background, optimization of adjustable machine parameters may be performed. However, the known optimization methods may have the disadvantage that the quality of the characteristic curves saved in the control and regulation devices may depend on the actual run-through or executed operating points. If the machine and harvested material parameters change abruptly, the control and regulation device must operate in a different range of the saved characteristic curve fields, which may lead to these characteristic curve ranges first having to be adapted to the new boundary conditions, such as the harvested material properties. This may result in the control and regulation system requiring a certain response time in the event of abruptly changing conditions before the control and regulation system may optimally operate again.

Thus, typically an agricultural work machine may have the disadvantage that unfavorable boundary conditions (e.g., locally above-average straw moisture) or unfavorable external influencing factors (e.g., strong change in slope or end of crop) may lead to a distorted result of the activation of measuring points or distorted measurement results. It may even be that the activation of measuring points has to be aborted if the external influencing factors acting on the agricultural work machine change too much.

For example, the agricultural work machine may be in a critical state (alternatively termed a critical condition). For example, a critical state may be an operating state or working state in which the agricultural work machine is disturbed during the operational task. In other words, a critical state may be a situation in which the agricultural work machine is negatively affected during operation. Examples that may lead to a critical state may be unevenness in the terrain, static obstacles (e.g., power poles or water holes), poor conditions of the harvested material to be harvested (e.g., high straw moisture), or harvested material jams. Other examples may include interruptions or sand crests (e.g., detectable by means of below-average straw moisture or stops in the operation of the agricultural work machine).

If measurements are performed in a critical state (e.g., if the measuring points are controlled in the critical state of the agricultural work machine), the result of the activation or measurement may be of poor or lower quality. Moreover, the agricultural work machine may be negatively influenced by the activation of the measuring points because the controlled measuring points are located in or on the edge regions of the characteristic curve field and/or outside the active operating range of the given characteristic curve field. For example, the activation of the measuring points could lead to a lower quantity of harvested material because the agricultural work machine is not operating at the best possible or optimal operating point.

If the agricultural work machine is in a critical state during the optimization method or during the activation of the measuring points (or if the agricultural work machine changes to a critical state), the measuring points may thus be unusable or of lower quality and may not be used any further. In this case, activating the measuring points would have been unnecessary.

Thus, one object of the present invention is to disclose a control and regulation device of an agricultural work machine that comprises higher-quality regulation of the agricultural work machine. This may be using the disclosed control and regulation device.

In one or some embodiments, an agricultural work machine comprises at least one control and regulation device, which is configured to use saved characteristic curve fields for an automatable setting and monitoring of working and/or quality parameters of the agricultural work machine, which may influence or affect a harvesting process, and at least one display device (e.g., a touchscreen) configured to display target values and/or actual values of the work parameters and/or quality parameters. The saved characteristic curve field may be formed by or comprise characteristic curves. The characteristic curves may describe various evaluation variables of the agricultural work machine as a function of influencing variables. The evaluation variables may be formed by or comprise quality parameters, and the influencing variables by or comprise work parameters. In one or some embodiments, the characteristic curve field comprises operating points located in an active work region and measuring points located in the peripheral region(s) and/or outside the active work region. In one or some embodiments, the agricultural work machine may comprise a combine harvester. The active work region may comprise the region of the characteristic curve field in which the agricultural work machine is working or operating. In one or some embodiments, the control and regulation device is configured to determine the operating points in the harvesting process and transfer the operating points to the respective characteristic curve field. The region of the given characteristic curve field comprising or including the operating points may form the active work region of the characteristic curve field. The control and regulation device may also be configured to activate defined measuring points in the saved characteristic curve fields. These specifically activated measuring points may be located in the edge region(s) of the characteristic curve field and/or outside the active operating region of the given characteristic curve field. The measuring points may be activated when the agricultural work machine is in an uncritical state (e.g., the control and regulation device may be configured to determine whether the agricultural work machine is in an uncritical state (e.g., a state other than the critical state, such as a working state); responsive to the determination, the control and regulation device may activate the measuring points).

In other words, such an agricultural work machine may enable a measuring point (or a plurality of measuring points) to be activated only while the agricultural work machine is in a non-critical state. This may mean that the activation of the measuring points may be performed undisturbed. The activated measuring points may also have a particularly higher quality and a lower measurement error.

In one or some embodiments, the non-critical state may be an operating state or working state in which the agricultural work machine performs an operational task (e.g., a harvesting process) undisturbed. For example, the agricultural work machine may perform an operational task without reporting critical errors and/or encountering unexpected problems. A non-critical state may also mean that the agricultural work machine is working under quasi-stationary conditions and is not disturbed by any obstacles (e.g., a tree or a hollow). The non-critical state may be regarded as a state in which the agricultural work machine is operating smoothly and/or no immediate intervention is required. The non-critical state may exist as long as the agricultural work machine operates efficiently on its predefined work region (e.g., a region “field without a tree”) and fulfills its task. Thus, a non-critical state may be, for example, an undisturbed harvesting process.

One advantage of such an agricultural work machine may be that a higher-quality and robust control system may be provided. Furthermore, the agricultural work machine may have the advantage that the saved characteristic curve field enables a good working result of the agricultural work machine in at least part, such as the entire, saved value range, even under strongly fluctuating working conditions.

Another advantage may be efficient activation of the measuring points. The activating should, if at all possible, not be interrupted because the agricultural work machine is in a non-critical state. This may also mean that the measuring points may be activated more quickly. A further advantage may be, for example, a significantly improved quality of the measuring points and/or a characteristic curve field (or model of a characteristic curve field). Overall, a higher quality and efficiency of the harvesting process may also be expected because the activation of the measuring points may be performed less frequently.

One embodiment of the first aspect may relate to an agricultural work machine, wherein the non-critical state is determined based on a digital field map, wherein the digital field map optionally includes an obstacle region and a non-critical region.

In other words, the digital field map may include a region for a non-critical state and a region that has obstacles. The agricultural work machine may access the digital field map to obtain information on whether the region in which the agricultural work machine is currently located is suitable for activating the measurement points (e.g., the control and regulation device determines that the agricultural work machine is in the region for the non-critical state).

The digital field map may be a representation of the environment, such as the field environment. The digital field map may be a digital medium for representing the earth's surface. In one or some embodiments, the digital field map may be a flattened, reduced and/or generalized image of the earth's surface with descriptions and symbols.

The digital field map may be prepared (e.g., as part of a computer process) and then transmitted to the agricultural work machine for storage therein. In the same way, optimizations may be made to the digital field map on the computer. The driver or operator may also perform the optimizations while driving in the driver assistance system or on a mobile device.

The digital field map may include digital documents, images and/or videos. The digital field map may be saved on a computer-readable medium or a data carrier, such as saved in a device in or proximate to (e.g., a mobile device) the agricultural work machine.

The digital field map may include various regions that depict the surroundings. In one or some embodiments, a region may be a tract with a specific boundary or an area. The non-critical region may be a region in which the agricultural work machine is in a non-critical state. The obstacle region may be a region that the agricultural work machine must avoid or drive around.

Examples of the obstacle region may refer to partial widths and/or turning regions. Examples of the region for the non-critical state may refer to areas for undisturbed harvesting.

One advantage of the digital field map may be a precise calculation of the path length that the agricultural work machine will cover in a non-critical state.

One embodiment of the first aspect may relate to an agricultural work machine, wherein the non-critical region and/or the obstacle region is determined based on any one, any combination, or all of the following: a field region of the agricultural work machine; a working direction of the agricultural work machine; a turning region; at least one static obstacle; at least one detected partial width; at least one field enclosure; at least one storage grain; a straw moisture; a yield forecast determined using satellite images; or a field quality (wherein the field quality may be determined based on drone images and/or growth models).

In one or some embodiments, the field quality may be a forecast field quality that is determined by remote sensing, for example. The field quality may also be determined on the basis of images, wherein the images record previous lanes using sensors.

One embodiment of the first aspect may relate to an agricultural work machine, wherein the non-critical state comprises a non-critical time period, and wherein the non-critical time period may be determined based on any one, any combination, or all of the following: the digital field map; a driving speed of the agricultural work machine; or a working direction of the agricultural work machine.

The non-critical period may be a phase or time span in which the agricultural work machine performs an operational task undisturbed. The non-critical period may comprise a start time and an end time. The agricultural work machine may perform the operational task from the start time to the end time.

Using the non-critical period, it may be advantageously ascertained how long the agricultural work machine is in the non-critical state. It may be possible for the non-critical period to be determined using the digital field map. For example, the system (e.g., the control and regulation device) may determine, using the digital field map, how long the agricultural work machine is or will be in the non-critical state. In this way, a start time of the non-critical period may be determined, wherein the activation of the measuring points may begin at the start time. Alternatively, or in addition, an end time of the non-critical period may be determined, wherein the activation of the measuring points should be completed at the end time. Accordingly, the measuring points may be activated during the non-critical period.

One embodiment of the first aspect may relate to an agricultural work machine, wherein the digital field map is adapted using historical data and/or using current field measurements.

The historical data may include information and/or records from the past that may be used to analyze and understand themes, trends, patterns and changes in the behavior of the environment or field environment. The current field measurements may include measurements of the environment or field environment, which may be recorded, for example, using a sensor system of the agricultural work machine during operation (e.g., during the harvesting process).

In one or some embodiments, the digital field map may be improved using historical data and/or current field measurements because further information is added to the digital field map. In one or some embodiments, the digital field map may be constantly updated or brought up to date by using the current field measurements.

One embodiment of the first aspect may relate to an agricultural work machine, wherein the non-critical state is determined based on any one, any combination, or all of the following and/or wherein the digital field map is determined based on any one, any combination, or all of the following: a topology map; data recorded using on-board environmental sensors; data based on the current harvest conditions; satellite images and/or yield forecasts determined using satellite images; or GPS data.

In other words, the non-critical state and/or the digital field map may be derived by means of a topology map or one of the aforementioned data. For example, the system, such as the control and regulation device, may determine, using computer-implemented methods and based on the topology map, that the agricultural work machine is in a non-critical state. The digital field map may further include a topology map and/or other data (e.g., data detected using on-board environmental sensors and/or data based on the current harvesting conditions).

The topology map (also termed a topographic map) may be a medium to large-scale map that serves to accurately depict the terrain (topography) and other visible details of the earth's surface. The terrain (e.g., a field environment) may be represented by contour lines, supplemented by any one, any combination, or all of: prominent elevation points (e.g., peaks, saddles, etc.); the course of bodies of water; roads; railroad lines; larger buildings; or the outlines of towns and other technical features such as fences, boundaries, water or power lines.

Data detected or generated by on-board environmental sensors may refer to information that was collected by one or more sensors, which may be mounted directly on board the agricultural work machine to monitor the environment. Satellite images and/or yield predictions determined using satellite images may refer to the use of satellite images to collect information about agricultural areas, such as soil moisture, vegetation patterns or pest infestation, to generate yield predictions. GPS data may be information that is detected and transmitted by GPS satellite systems to determine the exact geographic location of an object or person.

In this regard, the digital field map may be determined based on remote sensing, such as satellite data or historical data. Alternatively, the digital field map may be determined based on a yield forecast or a change in the forecast yield.

One embodiment of the first aspect may relate to an agricultural work machine, wherein a notice may be displayed on the display device when the agricultural work machine is in a non-critical state.

An advantage of this embodiment may be, for example, that the operator of the agricultural work machine may be informed quickly and precisely about the non-critical state via the notice on the display device. Furthermore, the operator may be informed via the notice that the measuring points are being activated.

Another option may be to display a further notice on the display device when the agricultural work machine is in a critical state. Accordingly, the operator may be informed via the additional notice that the measuring points are not being activated.

One embodiment of the first aspect may relate to an agricultural work machine, wherein the work parameters comprise the parameters “machine parameter setting” and/or “harvested material parameters”; and/or wherein the quality parameters comprise the parameters of any one, any combination, or all of “separation loss”, “cleaning loss”, “returns”, “returns volume”, “grain content in the returns”, “grain breakage”, “contamination” or “threshing loss”.

A second aspect may relate to an agricultural network comprising a plurality of agricultural work machines, wherein the agricultural work machines are assigned to a common digital field map.

In other words, many agricultural work machines may access a digital field map together, individually, in concert, or in combination, and therefore may exchange information with the digital field map. This may enable a non-critical state to be determined for each of the agricultural work machines, wherein the non-critical states may be coordinated with one another.

The disclosed methods may be implemented or saved in a computer readable medium (e.g., tangible memory configured to store computer-executable instructions) in the form of instructions in software or on a computer program product, wherein saved instructions may enable the steps according to the method to be performed when a corresponding data processing machine is controlled by the software. In other words, it is possible for the methods to be computer-implemented methods. Embodiments therefore may also relate to a storage medium with software saved thereon, which is configured to perform the presented methods when the software is executed on a data processing device.

As a general matter, the described method may also apply to a corresponding device for performing the method or a corresponding system that comprises one or more devices, and vice versa. For example, if a particular method step is described, a corresponding device may contain a feature for performing the described method step, even if this feature is not explicitly described or shown in the figure. On the other hand, if, for example, a particular device is described on the basis of functional units, a corresponding method may contain one or more steps for performing the described functionality even if these steps are not explicitly described or shown in the figures. Similarly, a system may include a corresponding device feature or features for performing a particular step of the method. The features of the various exemplary aspects and embodiments described above or below may be combined, provided that something different is not explicitly stated.

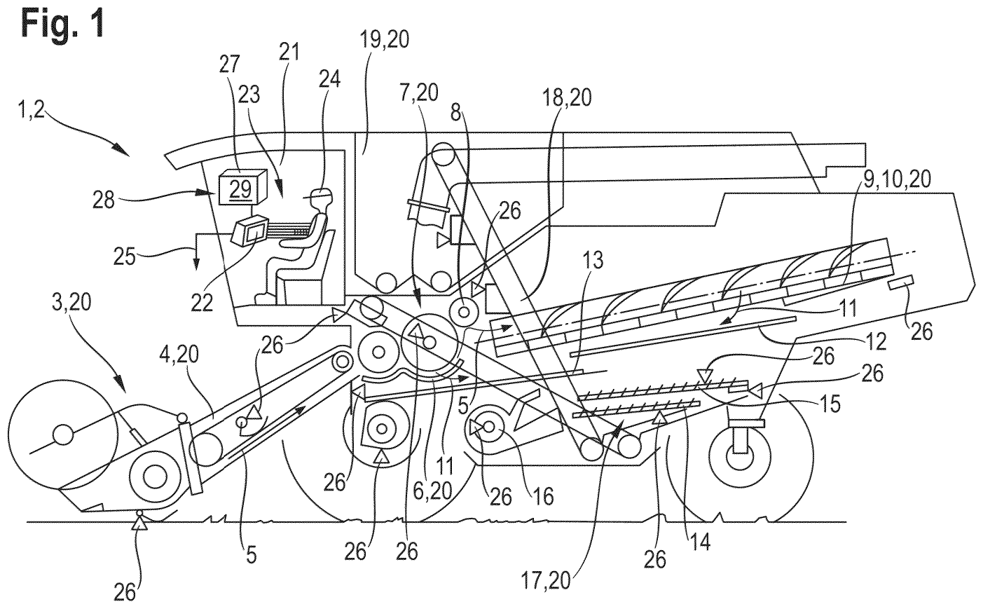

Referring to the figures, details relating to an agricultural work machine 1 are described in detail in US Patent Application Publication No. 2014/0019017 A1, incorporated by reference herein in its entirety. The agricultural work machine 1, which may comprise a combine 2 that is schematically represented in FIG. 1, is configured to receive or attach to a grain header 3 in its front region, which may be connected in a known manner to the inclined conveyor 4 of the combine 2. The flow of harvested material 5 passing through the inclined conveyor 4 may be transferred in the upper rear region of the inclined conveyor 4 to the threshing units 7 of the combine 2, which may at least partially be surrounded by a so-called threshing concave 6 on the bottom. A diverter roller 8 downstream from the threshing units 7 may divert the flow of material 5 out of the threshing units 7 in their rearward region so that the flow is transferred (such as immediately transferred) to a separating device 10 that may comprise a separating rotor 9. The flow of material 5 in the rotating separating rotor 9 may be conveyed such that freely movable grains 11 contained in the flow of material 5 are removed in the bottom region of the separating rotor 9. Within the context of the invention, the separating device 10 portrayed in the disclosed embodiment that is designed as a separating rotor 9 may also be designed as a known, and therefore not shown, straw walker. The grains 11 deposited both on the threshing concave 6 as well as on the separating rotor 9 may be fed over a returns pan 12 and a feed pan 13 of a cleaning device 17 comprising (or consisting of) a plurality of screening levels 14, 15 and a fan 16. The cleaned flow of grains may then be transferred using elevators 18 to a grain tank 19. As such, the grain header 3, the inclined conveyor 4, the threshing units 7 and the threshing concave 6 assigned to them, the separating device 10, the cleaning device 17, the elevators 18 and the grain tank 19 may be termed working units 20 of the agricultural working machine 1, discussed further below.

Furthermore, the agricultural working machine 1 may have a vehicle cabin 21. In one or some embodiments, at least one control and regulation device 23 may be arranged or positioned within the vehicle cabin. The control and regulation device 23 may include a display unit 22 (e.g., a touchscreen), through which a plurality of processes which are known per se and are therefore not further explained may be controlled, initiated automatically or by an operator 24 of the agricultural working machine 1. The control and regulation device 23 may be configured to communicate with a plurality of sensor systems 26 via a so-called bus system 25 in a manner known per se. Details relating to the structure of the sensor systems 26 are described in detail in US Patent Application Publication No. 2003/0066277 A1, the entire content of which is hereby incorporated by reference herein, so that the structure of the sensor systems 26 is not described further. Moreover, the control and regulation device 23 is coupled to a driver assistance system 28, which may comprise a display unit 27 (e.g., a touchscreen). In one or some embodiments, driver assistance system 28 (along with display unit 27) may be separate from control and regulation device 23 (and display unit 22). Alternatively, the driver assistance system 28 and the control and regulation device 23 may be integrated (with a single display unit that may comprise a touchscreen). In particular, the driver assistance system 28 may be integrated directly in the control and regulation device 23, and the information provided by the driver assistance system 28 and explained in greater detail below may also be visualized directly in the display unit 22 assigned to the control and regulation device 23.

FIG. 1 shows a schematic representation of the display unit 22 of the control and regulation device 23 and the computing unit 30 associated with the control and regulation device 23 and coupled to the display unit 22. In one or some embodiments, the computing unit 30 may comprise at least one processor 600 (configured to perform the functionality of the control and regulation device 23 and/or the driver assistance system 28), at least one memory 602 (configured to store data, such as information 33 and/or computer-executable instructions stored on the tangible memory), and at least one communication interface 604 (configured to communication with devices external to the computing unit, such as the sensor systems 26 via bus system 25). The at least one processor 600 and at least one memory 602 may be in communication (e.g., wired and/or wirelessly) with one another. In one or some embodiments, the processor 600 may comprise a microprocessor, controller, PLA, or the like. Similarly, the memory 602 may comprise any type of storage device (e.g., any type of memory, such as RAM, ROM, or a combination thereof). Though the processor 600 and the memory 602 are depicted as separate elements, they may be part of a single machine, which includes a microprocessor (or other type of controller) and a memory. Alternatively, the processor 600 may rely on the memory 602 for all of its memory needs. Still alternatively, the processor 600 may rely on a database for some or all of its memory needs. The memory 602 may comprise a tangible computer-readable medium that include software that, when executed by the processor 600 is configured to perform any one, any combination, or all of the functionality described herein, such the disclosed functionality of the control and regulation device 23 and/or the driver assistance system 28. Further, the communication interface 604 may be configured to communicate (e.g., wired and/or wirelessly) with one or more electronic devices.

The processor 600 and the memory 602 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

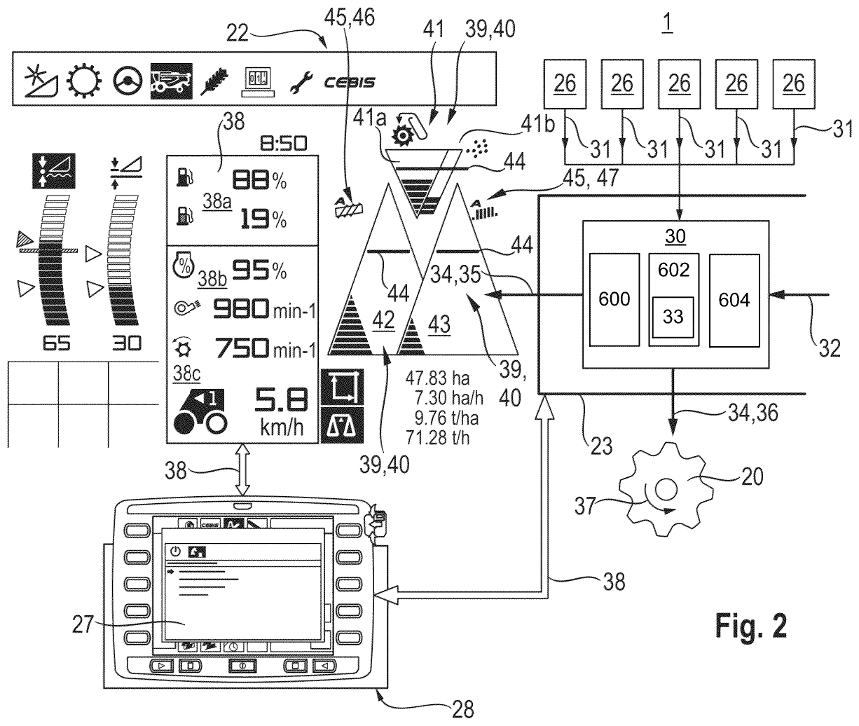

In this regard, the computing unit 30 may be such that, in addition to the internal information 31 generated by the sensor systems 26, it may process external information 32 and information 33 saved in the memory 602 of the computing unit 30 itself, such as expert knowledge, into a plurality of output signals 34. The output signals 34 may be such that they comprise at least display control signals 35 and working unit control signals 36, wherein the former may determine the contents of the display unit 22 and the latter may cause the change in the various work parameters 37 of the working units 20 of the agricultural work machine 1, wherein arrow 37 symbolically represents the threshing drum rotational speed. In addition, as already described, the control and regulation device 23 may be coupled to a driver assistance system 28, wherein the driver assistance system 28 may be integrated into the agricultural work machine 1 in such a way that it may exchange data or information in a manner to be described in more detail both with the control and regulation device 23 and with the display unit 22 associated therewith. The contents of the display units 22, 27 shown in FIG. 2 are exemplary and are described in more detail below. In its central region, the display unit 22 assigned to the control and regulation device 23 may comprise a so-called hotkey window 38 freely definable by the operator 24 and in which important machine information, such as the fill level of the fuel tank 38a, machine parameter settings 38b and the travel speed 38c are visualized.

In one or some embodiments, the display unit 22 comprises display elements 39 in its right-sided region for visualizing current values of certain quality parameters 40 of the agricultural work machine 1. In the illustrated embodiment, the display element 39 arranged at the top visualizes the composition of the so-called “returns” 41, whereby the left-sided display visualizes the “returns volume” 41a and the right-sided display visualizes the “grain proportion in the returns” 41b. The lower, left-hand display element 39 visualizes the so-called “separation losses” 42 (e.g. those grain losses that are discharged from the separating device 10 designed as a separating rotor 9 or straw walker, in the rear region of the agricultural work machine 1 and are not conveyed into the grain tank 19). The lower, right-hand display element 39 visualizes the so-called “cleaning losses” 43, wherein those grain losses are displayed here which are discharged from the agricultural work machine 1 by the cleaning device 17 in a manner analogous to the separating device 10 and are not conveyed into the grain tank 19. Each of the display elements 39 may also comprise a setpoint indicator 44 designed as a horizontal line, which may define the maximum permissible loss level of the given quality parameter 40 previously defined by the operator 24 so that the operator 24 may quickly determine whether the agricultural work machine 1 has a sufficient working quality.

Due to the complex relationships between various machine parameters 38a-c and at least the quality parameters 40, the setting options for the separating device 10 and the cleaning device 17 may be saved in so-called automatic setting units 45. In the illustrated embodiment in FIG. 2, an automatic separating unit 46 for optimizing the mode of operation of the separating device 10 and an automatic cleaning unit 47 for optimizing the mode of operation of the cleaning device 17 are programmed and saved in the control and regulation device 23. It is contemplated that each of the available automatic setting units 45 may also be saved in whole or in part in the driver assistance system 28.

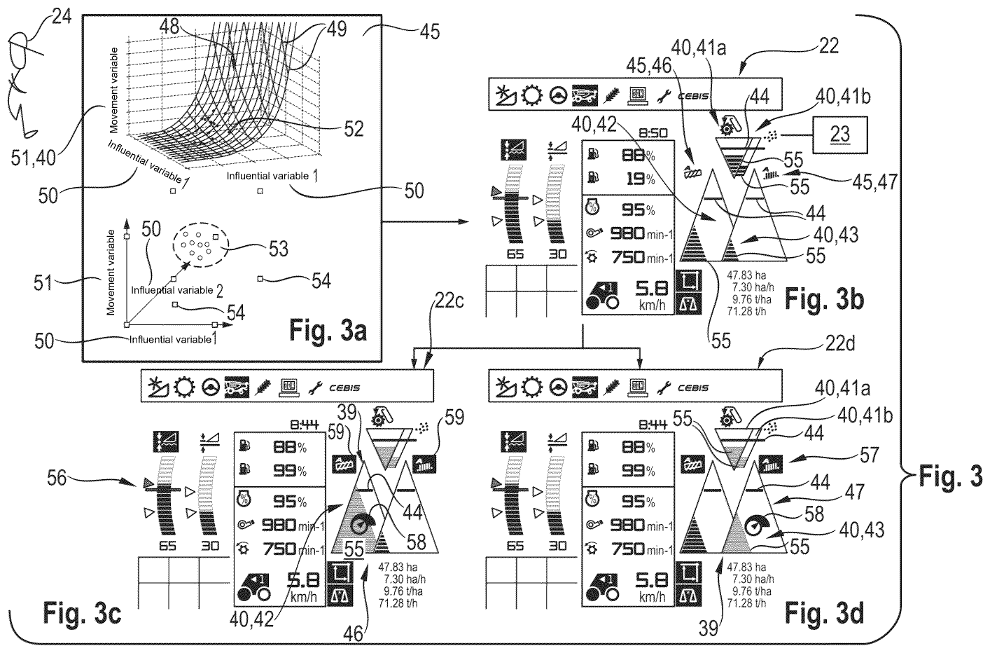

FIG. 3, which includes FIGS. 3a-d, describes in more detail using schematic illustrations of the display unit 22 associated with the control and regulation device 23 and the available automatic setting units 45. In particular, FIG. 3a shows a schematic structure of the available automatic setting units 45 for a better understanding of their mode of operation. Both the automatic separating unit 46 and the automatic cleaning unit 47, as well as some or every other automatic setting unit 45 provided for the adjustment of working units 20 of the agricultural work machine 1, may be defined by characteristic curve fields 48. The characteristic curves 49 forming a characteristic curve field 48 may describe various evaluation variables 51 of the agricultural work machine 1 as a function of influencing variables 50. In the present case, the evaluation variable 51 may form the quality parameters 40 described above. In the illustrated embodiment, the influencing variables 50 comprise any one, any combination or all of the rotational speed of a separating device 10 designed as a separating rotor 9, the rotational speed of the fan 16 associated with the cleaning device 17, and the opening width of the screening levels 14, 15. During the job of the agricultural work machine 1, in this case the harvesting operation of the combine harvester 2, the determined operating points 52 may directly be transferred to the characteristic curve field 48. According to the lower illustration in FIG. 3a, the agricultural work machine 1 may often only operate in a small region 53 of the saved characteristic curve field 48. To ensure that the characteristic curve field 48 saved in the control and regulation device 23 accurately reproduces the separation or cleaning process to be modeled in the entire predefined value range, measuring points 54 are approached at regular intervals that are not in the currently traversed region 53 of the given characteristic curve field 48 and/or in its border regions. This may have the effect that the separation or cleaning models saved in the automatic setting units 45 also reproduce the given process with sufficient accuracy in the border region of the characteristic curve fields 48 and in regions of the given characteristic curve field 48 that are not currently being traversed.

If the agricultural work machine 1 (e.g., the combine harvester 2 depicted) is operated with activated automatic separating unit 46 and activated automatic cleaning unit 47, the display unit 22 assigned to the control and regulation device 23 has the structure shown in FIG. 3b and described above. The value of each quality parameter 40, in this case the “returns volume” 41a, the “grain content in the returns” 41b, the “separation loss” 42 and the “cleaning loss” 43, may be visualized qualitatively in the form of areas 55 highlighted therein. Each of the areas 55 may change its extent depending on the values determined by the control and regulation device 23 for “separation loss” 42, “grain loss” 43 and “returns composition” 41a, 41b, wherein it is the task of the automatic setting units 45 to keep the quality parameter 40 at an optimum and below the given setpoint indicator 44.

If a defined measuring point 54 must be approached by the automatic setting units 45, two activation states 56, 57 may result for the embodiment described here according to FIGS. 3c and 3d. In the one activation state 56, FIG. 3c, the automatic separating unit 46 may automatically move to a measuring point 54 that is either outside the region 53 currently being traversed or in the border region of the characteristic curve field 48 describing the grain separation on the separating device 10. So that the operator 24 of the agricultural work machine 1 may be informed that the automatic separating unit 46 is approaching a measuring point 54 that does not lie in the current work region 53, the area 55 visualizing the quality parameter 40 “separation loss” 42 is shown fading in the display unit 22c. In addition, it may be provided that the area 55 shown fading is either frozen in its size or continues to visualize the change in the “separation loss” 42. The latter variant may keep the operator 24 informed about the course of the change, which may also lead to the “separation losses” 42 briefly exceeding the mark of the setpoint indicator 44 before reaching a steady state. In order to signal the optimization of a measuring point 54, which may not lie in the current working region 53 in a manner which is easily recognizable for the operator 24, it is provided that the display element 39 visualizing the “separation loss” 42 is at least partially covered by a characteristic symbol 58, while the partially covered working parameter 37 and/or quality parameter 40 is displayed passively, such as fading.

In a similar way, the structure of the display unit 22 may be adapted in the further activation state 57 according to FIG. 3d. In this case, the automatic cleaning unit 47 may automatically move to a measuring point 54 that is either outside the region 53 that has just been traversed or in the border region of the characteristic curve field 48 describing the grain separation at the cleaning device 17. So that the operator 24 of the agricultural work machine 1 may be informed that the automatic cleaning unit 47 is approaching a measuring point 54 that does not lie in the current work region 53, the areas 55 visualizing the quality parameters 40 “cleaning loss” 43, “returns volume” 41a, “grain content in the returns” 41b are shown fading in the display unit 22d. In addition, it may be provided that the fading areas 55 are either frozen in their size or continue to visualize the change in the “cleaning losses” 43, the “returns volume” 41a and the “grain content in the returns” 41b. The latter variant may keep the operator 24 informed about the course of the changes, which may also lead to the “cleaning losses” 43, the “returns volume” 41a and the “grain content in the returns” 41b briefly exceeding the mark of the given setpoint indicators 44 before a steady state is reached. In order to signal the optimization of a measuring point 54 which does not lie in the current working region 53 in a manner which is easily recognizable for the operator 24, it is also provided here that at least the display element 39 visualizing the “cleaning loss” 43 is at least partially covered by a characteristic symbol 58, while the partially covered working parameter 37 and/or quality parameter 40 is displayed passively, such as fading.

In a manner known per se, each of the existing automatic setting units 45 may be activated and deactivated independently of one another, either automatically or triggered by the operator 24 (e.g., via the touchscreen) so that the number of automatic setting units 45 operating simultaneously may be selected as desired.

In one or some embodiments, some or all automatic setting units 45 may always be activated to optimize the mode of operation of the agricultural work machine 1. It is contemplated that a selective deactivation of an automatic setting unit 45 may also be effected by the operator 24 selectively changing a work parameter 37 by entering a defined value (e.g., via the touchscreen).

If the override by the operator 24 takes place during the targeted approach of measuring points 54, the characteristic symbols 58 may be faded out and the possibly fading display of the work parameters 37 and/or quality parameters 40 may be canceled. In this context, it may also be provided that the operator 24 receives an explicit notice in the display unit 22 of the deactivation of the automatic setting units 45.

Since the control and regulation device 23 is designed in a manner known per se such that it may always visualize the change in the quality parameters 40, independent of whether or not the automatic setting units 45 are activated, it may be provided in a further embodiment that pictograms 59 representing the automatic setting units 45 are positioned in the display unit 22, which may be visualized at least highlighted in color when the automatic setting unit 45 is active. The deactivation of the given automatic setting unit 45 may accordingly be visualized by dimming the given pictogram 59.

Furthermore, in one or some embodiments, each automatic setting unit 45 has its own characteristic curve field 48, wherein individual automatic setting units 45 may also cause an optimization of the mode of operation of the agricultural work machine 1 by including a plurality of characteristic curve fields 48. In the depicted embodiment, the automatic cleaning unit 47 may take into account characteristic curve fields 48, which may take into account both the “cleaning losses” 43 and the “returns volume” 41a and the “grain content in the returns” 41b. To ensure that the taken into account characteristic curve fields 48 provide useful values for the evaluation variables 51 and therefore for optimum mode of operation of the agricultural work machine 1 even with fluctuating influencing variables 50, it is provided that the approach of measuring points 54 that are not in the current working region 53 or in the border regions of the characteristic curve fields 48 takes place at defined time intervals and is restricted to a specific number of measuring points 54. In one or some embodiments, the number of specifically activatable measuring points 54 is limited to four.

In addition, in one or some embodiments, the control and regulation device 23 and therefore also the automatic setting units 45 may be automatically activated responsive to the agricultural work machine 1 being put into operation (e.g., the control and regulation device 23 determines the beginning of operation of the agricultural work machine 1). In this context, responsive to determining that the automatic setting units 45 are inactive (e.g., the control and regulation device 23 makes this determination), a notification of an increase in efficiency may be generated to the operator 24 by activating the given automatic setting unit 45 (e.g., the control and regulation device 23 may generate an output on display unit 22).

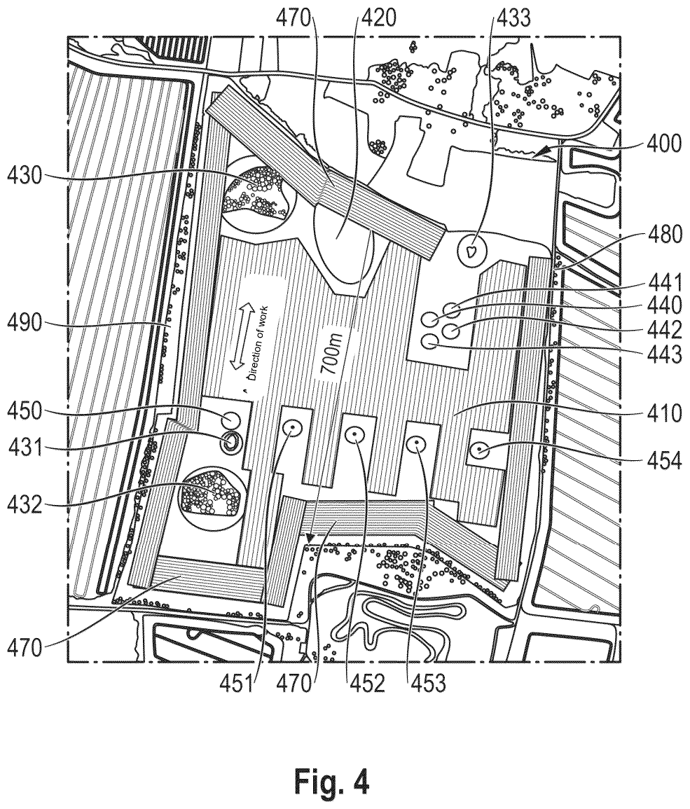

FIG. 4 shows an example schematic representation of the digital field map 400. The agricultural work machine 1 may access the digital field map 400 in order to obtain information as to whether the region in which the agricultural work machine 1 is currently located is suitable for performing an optimization method or for activating the measuring points 54.

The digital field map 400 may comprise various objects and areas of a field or a field environment. For example, the digital field map 400 may include a work area 410 that represents an area on which the agricultural work machine 1 may perform an operational task undisturbed. For example, the agricultural work machine 1 could perform a harvesting process on the work area 410.

Furthermore, the digital field map 400 may comprise a plurality of obstacles (e.g., objects that the agricultural work machine 1 must avoid or drive around). For example, the digital field map 400 may include an area 420 with an above-average straw moisture. Furthermore, the digital field map 400 comprises a plurality of field enclosures 430, 431, 432 and 433. Further, the field map 400 includes a plurality of locations 440, 441, 442 and 443 at which stored grain is positioned and a plurality of static obstacles 450, 451, 452, 453 and 454 (e.g., trees or bushes, for example, which the agricultural work machine 1 must avoid).

The digital field map 400 may also include areas on which the activation of measuring points could lead to poor results. These include, for example, part width sections 460 and turning region 470.

A partial width section 460 may be the edge region of a field that cannot or may only be partially worked because the working width of the agricultural work machine 1 is wider than the available edge region of the field. A turning region 470 may be the edge region of a field on which the agricultural work machine 1 may be turned.

Typically, the field to be worked is bordered by a fence 480 and/or a field boundary 490. Field boundaries may be defined digitally (e.g., by the farmer or by clearing). At the beginning, the headland (e.g., the turning region) may be cut free, which may allow the field boundaries to be driven over. The field boundaries may be defined during sowing. Natural obstacles (fallen trees, soil erosion, etc.) but also man-made influences (e.g., soil preparation) may cause changes during the growing season.

The agricultural work machine 1 usually moves in one working direction during the harvesting process. All obstacles may typically be bypassed by the agricultural work machine 1, or the agricultural work machine 1 cannot harvest or may only harvest to a limited extent in this area.

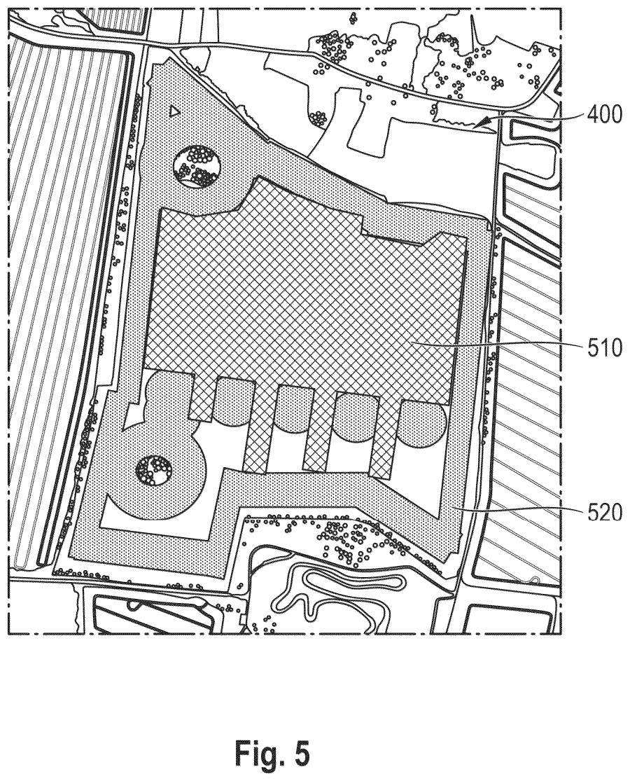

FIG. 5 shows a schematic representation of the digital field map 400 comprising an obstacle region 520 and a non-critical region 510.

The digital field map 400 shown in FIG. 4 was subjected to a processing step so that the digital field map 400 depicts two regions, namely the obstacle region 520 and the non-critical region 510.

In the processing step, the obstacle region 520 was determined by generating a contiguous area based on the plurality of obstacles (e.g., the static obstacles 450, 451, 452, 453, and 454). In other words, the obstacle region 520 was determined using one, some or all of the aforementioned obstacles (e.g., based on any one, any combination, or all of field enclosure 430, 431, 432 and 433, at least one static obstacle 450, 451, 452, 453 and 454, at least one detected width section 460, a turning region 470, at least one saved grain, or at least one straw moisture).

Furthermore, it is also possible for additional data to be used to determine the obstacle region 520, for example by means of satellite images of certain yield forecasts and/or a field quality, wherein the field quality is determined based on drone images and/or growth models.

A non-critical region 510 may also be determined during the processing step. Based on the non-critical region 510, it may be determined when and for how long the agricultural work machine 1 may be in the non-critical state. In the non-critical region 510, the agricultural work machine 1 may work under quasi-stationary conditions and may not be disturbed by any obstacles (e.g., a tree). It may therefore be possible to be able to better plan the activation of the measuring points 54.

For example, based on the digital field map 400, it may be determined that the agricultural work machine 1 is in the non-critical state, wherein the non-critical state comprises a non-critical period of time. The non-critical period may be determined using the digital field map 400, such as by determining the duration in the non-critical region 510 using the driving speed of the agricultural work machine 1 and the working direction of the agricultural work machine 1. The non-critical period may be 15 minutes, for example. If a duration of the activation of the measuring points 54 is expected to be one minute, the control and regulation device 23 may determine that the activation of the measuring points 54 takes place within the non-critical period (e.g., while the agricultural work machine 1 is in the non-critical state).

In a further example, the correct location or time for the activation of the measuring points 54 may be determined. If, for example, it is foreseeable that the duration of the activation of the measuring points 54 is approximately 15 seconds, the digital field map 400 and the non-critical region 510 may be used to determine where and when the activation of the measuring points 54 should take place. A required distance for the activation of the measuring points 54 may be determined by means of the working direction and/or the driving speed of the agricultural work machine 1. For example, if the driving speed is approximately 4 km per hour (e.g., approximately 1.15 meters per second), a necessary distance with a length of approximately 18 meters may be required for activating the measuring points 54. The control and regulation device 23 may determine by means of the information about the necessary distance where and from when the activation of the measuring points 54 should take place within the non-critical region 510. A region or location in the non-critical region 510 may be determined in which the agricultural work machine 1 is currently departing and does not have to turn (e.g., may perform the harvesting process undisturbed).

When the agricultural work machine 1 is in a non-critical state, a notice may appear on the display unit 22 (e.g. the control and regulation device 23 may generate the notice on display unit 22). This may inform the operator that the measuring points may be activated.

It is of course possible for a large number of agricultural work machines 1 to jointly use the digital field map 400. For example, the digital field map 400 may be saved on a server, wherein each of the agricultural work machines 1 may exchange data with the server or the digital field map 400.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | | | |
|---|---|---|---|
| 1 | Agricultural work machine | 31 | Internal information |
| 2 | Combine harvester | 32 | External information |
| 3 | Grain header | 33 | Information |
| 4 | Inclined conveyor | 34 | Output signal |
| 5 | Harvested material flow | 35 | Display signal |
| 6 | Threshing concave | 36 | Working unit signal |
| 7 | Threshing unit | 37 | Operating parameter |
| 8 | Deflection drum | 38 | Hotkey window |
| 9 | Separating rotor | 39 | Display element |
| 10 | Separating device | 40 | Quality parameter |
| 11 | Grains | 41 | Returns |
| 12 | Returns pan | 41a | Returns volume |
| 13 | Feed pan | 41b | Grain content in the |
| 14 | Screening level | 42 | Separation loss |
| 15 | Screening level | 43 | Cleaning loss |
| 16 | Fan | 44 | Target value display |
| 17 | Cleaning device | 45 | Adjusting machine |
| 18 | Elevator | 46 | Automated separating unit |
| 19 | Grain tank | 47 | Automated cleaning unit |
| 20 | Working unit | 48 | Performance map |
| 21 | Vehicle cabin | 49 | Characteristic |
| 22 | Display unit | 50 | Influencing variable |
| 23 | Control and regulation device | 51 | Evaluation variable |
| 24 | Operator | 52 | Operating point |
| 25 | Bus system | 53 | Operating region |
| 26 | Sensor system | 54 | Measuring point |
| 27 | Display unit | 55 | Area |
| 28 | Driver assistance system | 56 | Control state |
| 29 | Information | 57 | Control state |
| 30 | Computing unit | 58 | Characteristic symbol |
| | | 59 | Pictogram |
| 400 | Digital field map | 510 | Non-critical region |
| 410 | Work area | 520 | Obstacle region |
| 420 | Area with above-average | 600 | Processor |
| | straw moisture | | |
| 430 | Field enclosure | 602 | Memory |
| 431 | Additional field enclosure | 604 | Communication interface |
| 432 | Additional field enclosure | | |
| 433 | Additional field enclosure | | |
| 440 | Place for stored grain | | |
| 441 | Further place for stored grain | | |
| 442 | Additional place for stored | | |
| | grain | | |
| 443 | Further place for stored grain | | |
| 450 | Static obstacle | | |
| 451 | Additional static obstacle | | |
| 452 | Additional static obstacle | | |
| 453 | Additional static obstacle | | |
| 454 | Additional static obstacle | | |
| 460 | Partial width | | |
| 470 | Turning region | | |
| 480 | Fence | | |
| 490 | Field boundary | | |

1. A combine harvester comprising:
at least one control and regulation device including:
at least one memory configured to store one or more characteristic curve fields for automatable setting and monitoring of one or both of working parameters or quality parameters of the combine harvester which affect a harvesting process, wherein the one or more characteristic curve fields are formed by one or more characteristic curves, wherein the one or more characteristic curves are indicative of a plurality of evaluation variables of the combine harvester as a function of influencing variables, wherein the plurality of evaluation variables are based on quality parameters, and the influencing variables are formed by work parameters, and the one or more characteristic curve fields comprise operating points located in an active operating region and measuring points located in one or both of edge regions or outside the active operating region, wherein the active operating region comprises a region of the one or more characteristic curve fields in which the combine harvester operates;
at least one display device configured to display one or more target values and one or more actual values of the one or both of the working parameters or the quality parameters; and
at least one processor configured to:
determine the operating points;
determine, based on the operating points, the active operating region of a respective characteristic field curve of the one or more characteristic field curves;
determine whether the combine harvester is in a non-critical state; and
responsive to determining that the combine harvester is in the non-critical state, activate respective measuring points in the respective characteristic curve field, wherein respective measuring points lie in one or both of the edge regions of the respective characteristic curve field or outside the active operating region of the respective characteristic curve field.

2. The combine harvester of claim 1, wherein the operating points form the active operating region of the characteristic curve field.

3. The combine harvester of claim 1, wherein the at least one processor is configured to determine the non-critical state based on a digital field map; and
wherein the digital field map comprises an obstacle region and a non-critical region.

4. The combine harvester of claim 3, wherein the at least one processor is configured to determine one or both of the non-critical region or the obstacle region based on at least one of the following: a field region of the combine harvester; a working direction of the combine harvester; a turning region; at least one static obstacle; at least one detected partial width; at least one field enclosure; at least one storage grain; a straw moisture; a yield forecast determined using satellite images; or a field quality, wherein the field quality is determined based on one or both of drone images or growth models.

5. The combine harvester of claim 3, wherein the at least one processor is configured to determine one or both of the non-critical region or the obstacle region based on each of the following: a field region of the combine harvester; a working direction of the combine harvester; a turning region; at least one static obstacle; at least one detected partial width; at least one field enclosure; at least one storage grain; a straw moisture; a yield forecast determined using satellite images; and a field quality, wherein the field quality is determined based on one or both of drone images or growth models.

6. The combine harvester of claim 3, wherein the non-critical state comprises a non-critical time period; and
wherein the at least one processor configured to determine the non-critical time period based on at least one of the following:
the digital field map;
a driving speed of the combine harvester; or
a working direction of the combine harvester.

7. The combine harvester of claim 3, wherein the non-critical state comprises a non-critical time period; and
wherein the at least one processor configured to determine the non-critical time period based on each of the following:
the digital field map;
a driving speed of the combine harvester; and
a working direction of the combine harvester.

8. The combine harvester of claim 3, wherein the digital field map is adapted using at least one of historical data or current field measurements.

9. The combine harvester of claim 3, wherein the digital field map is adapted using both of historical data and current field measurements.

10. The combine harvester of claim 1, wherein the at least one processor configured to determine the non-critical state based on at least one of the following:
a topology map;
data recorded using one or more on-board environmental sensors;
data based on current harvest conditions;
one or both of satellite images or yield forecasts determined using the satellite images; or
GPS data.

11. The combine harvester of claim 1, wherein the at least one processor is configured to determine the non-critical state based on a digital field map; and
wherein the at least one processor configured to determine the digital field map based on at least one of the following:
a topology map;
data recorded using one or more on-board environmental sensors;
data based on current harvest conditions;
one or both of satellite images or yield forecasts determined using the satellite images; or
GPS data.

12. The combine harvester of claim 1, wherein the at least one processor is configured to determine the non-critical state based on a digital field map; and
wherein the at least one processor configured to determine the non-critical state and the digital field map based on each of the following:
a topology map;
data recorded using one or more on-board environmental sensors;
data based on current harvest conditions;
one or both of satellite images or yield forecasts determined using the satellite images; or
GPS data.

13. The combine harvester of claim 1, wherein, responsive to determining that the combine harvester is in the non-critical state, the at least one processor is configured to generate, using the at least one display device, a notice indicative that the combine harvester in the non-critical state.

14. The combine harvester of claim 1, wherein the work parameters comprise one or both of machine parameter setting or harvested material parameters; or
wherein the quality parameters comprise one or more of: separation loss; cleaning loss; returns; returns volume; or grain content in the returns.

15. The combine harvester of claim 1, wherein the work parameters comprise machine parameter setting and harvested material parameters; or
wherein the quality parameters comprise: separation loss; cleaning loss; returns; returns volume; and grain content in the returns.

16. An agricultural network comprising:
a plurality of combine harvesters, each of the plurality of combine harvesters including:
at least one control and regulation device including:
at least one memory configured to store one or more characteristic curve fields for automatable setting and monitoring of one or both of working parameters or quality parameters of the combine harvester which affect a harvesting process, wherein the one or more characteristic curve fields are formed by one or more characteristic curves, wherein the one or more characteristic curves are indicative of a plurality of evaluation variables of the combine harvester as a function of influencing variables, wherein the plurality of evaluation variables are based on quality parameters, and the influencing variables are based on work parameters, and the one or more characteristic curve fields comprise operating points located in an active operating region and measuring points located in one or both of edge regions or outside the active operating region, wherein the active operating region comprises a region of the one or more characteristic curve fields in which the combine harvester operates;
at least one display device configured to display one or more target values and one or more actual values of the one or both of the working parameters or the quality parameters; and
at least one processor configured to:
determine the operating points;
determine, based on the operating points, the active operating region of a respective characteristic field curve of the one or more characteristic field curves;
determine whether the combine harvester is in a non-critical state; and
responsive to determining that the combine harvester is in the non-critical state, activate respective measuring points in the respective characteristic curve field, wherein respective measuring points lie in one or both of the edge regions of the respective characteristic curve field or outside the active operating region of the respective characteristic curve field; and
wherein the plurality of combine harvesters are assigned to a common digital field map.

17. The agricultural network of claim 16, wherein the operating points form the active operating region of the characteristic curve field.

18. The agricultural network of claim 16, wherein the at least one processor is configured to determine the non-critical state based on a digital field map; and
wherein the digital field map comprises an obstacle region and a non-critical region.

19. The agricultural network of claim 18, wherein the at least one processor is configured to determine one or both of the non-critical region or the obstacle region based on at least one of the following: a field region of the combine harvester; a working direction of the combine harvester; a turning region; at least one static obstacle; at least one detected partial width; at least one field enclosure; at least one storage grain; a straw moisture; a yield forecast determined using satellite images; or a field quality, wherein the field quality is determined based on one or both of drone images or growth models.

20. The agricultural network of claim 18, wherein the at least one processor is configured to determine one or both of the non-critical region or the obstacle region based on each of the following: a field region of the combine harvester; a working direction of the combine harvester; a turning region; at least one static obstacle; at least one detected partial width; at least one field enclosure; at least one storage grain; a straw moisture; a yield forecast determined using satellite images; and a field quality, wherein the field quality is determined based on one or both of drone images or growth models.
